(19) United States
(12) Patent Application Publication
(10) Pub. No.: US 2024/0309530 A1
(43) Pub. Date: Sep. 19, 2024

(54) METHODS AND DEVICES FOR ENRICHING A SUBSTRATE WITH AN ALKALI METAL, AND ELECTROLYTE

(71) Applicant: RENA Technologies GmbH, Gütenbach (DE)

(72) Inventors: Holger Kühnlein, Gütenbach (DE); Franck Delahaye, Gütenbach (DE); Mathias Kamp, Gütenbach (DE)

(21) Appl. No.: 18/579,718

(22) PCT Filed: Jul. 15, 2022
(86) PCT No.: PCT/DE2022/100506

§ 371 Date: Jan. 16, 2024

(30) Foreign Application Priority Data
Jul. 16, 2021 (DE) 10 2021 118 422.3
Jul. 19, 2021 (DE) 10 2021 118 609.9

(51) Int. Cl. C25C 1/02; H01M 4/04

(52) U.S. Cl. CPC C25C 1/02; H01M 4/0452

(57) ABSTRACT

Methods and devices for enriching a substrate with an alkali metal, in particular lithium, a method for using an enriched substrate as an electrode in a battery, and an electrolyte, are provided. The electrolyte is guided in a circuit through an electrolysis chamber having an anode and a cathode and through a reservoir vessel, for enrichment purposes. Alkali metal disposed in the reservoir vessel is oxidized and dissolved in the electrolyte. The substrate used as a cathode in the electrolysis chamber is enriched with the dissolved alkali metal.

The present invention relates to methods and devices for enriching a substrate with an alkali metal and to the use of such an enriched substrate as electrode in a battery, and to electrolytes.

Lithium-ion and lithium metal batteries are currently under development in which electrodes enriched with lithium are used. Typically, for enrichment, lithium is deposited electrochemically on the electrode to be enriched, which is generally referred to as plating, or lithium is embedded in an active material of the electrode, which is sometimes referred to as prelithiation. An alternative enrichment option is to electrochemically deposit lithium on a conductive substrate, for example a copper foil, which does not yet comprise any active material. In this case, the active material is provided by the deposition of the lithium.

The deposition of lithium on the electrode or the embedding of lithium into the electrode material can be effected in the so-called roll-to-roll process. In this case, a strip of electrode material, for example a copper foil, passes through a galvanic bath in which lithium ions are present. The electrolytes used are typically organic and anhydrous. The process is carried out in a dry or inert atmosphere.

Well-known systems use lithium hexafluorophosphate (LiPF₆) as conductive salt in carbonate-based electrolytes. Additional lithium ions in the electrolyte are provided by a soluble lithium anode. Such systems can offer operational advantages since the metallic lithium used as anode is available at relatively low cost. However, uniform deposition of lithium ions on a long roll-to-roll guided belt has proven difficult, as the field distribution between the cathode and the soluble anode changes during the deposition process.

Systems with an inert anode adopt a different approach. In this case, salts are used as a lithium source, which enables uniform distribution of the lithium ions to be achieved. However, a disadvantage is the comparatively high costs of these lithium salts, which essentially have to be continuously recharged. In addition, anode reactions can occur in which undesirable degradation products are formed.

For example, in such systems lithium chloride (LiCl) is used as salt in gamma-butyrolactone (GBL). This produces chlorine (Cl₂) at the anode, which is highly corrosive and therefore attacks the system. In particular, Cl₂ degrades the GBL, which must accordingly be purified of the reaction products and refilled continuously.

Against this background, one object of the present invention is to provide an alternative for the enrichment of a substrate with an alkali metal, in particular with lithium. In particular, it is an object of the present invention to enable an efficient, targeted and/or low-cost enrichment of a substrate with an alkali metal.

Furthermore, the invention is based on the object of enabling the production and/or use of batteries having such enriched electrodes.

These objects are achieved by methods and devices for enriching a substrate with an alkali metal and by the use and electrolytes as claimed in the independent claims.

In the method according to a first aspect of the invention for enriching a substrate with an alkali metal, in particular lithium, an electrolyte is guided in a circuit through an electrolysis chamber having a cathode and an anode and a reservoir vessel. Alkali metal, in particular lithium, disposed in the reservoir vessel, is oxidized and dissolved in the electrolyte. A substrate used as cathode in the electrolysis chamber is enriched with the dissolved alkali metal.

One aspect of the invention is based on the approach of generating ions of an alkali metal by oxidation thereof in a reservoir vessel and dissolving them in situ in an electrolyte. The electrolyte may be used to transport the ions into an electrolysis chamber, where a substrate is or can be expediently electrochemically enriched therewith. The solution of the alkali metal in the reservoir vessel enables the use of an inert electrode, so that the field distribution between the electrode and the substrate preferably used as cathode in the electrolysis chamber does not change in the course of the enrichment process. At the same time, the alkali metal in the reservoir vessel can be readily refilled at low cost. For example, the alkali metal can be disposed and refilled in the reservoir vessel as a pellet bed. In this respect, in addition to uniform enrichment over the substrate surface—due to the constant field distribution—this procedure also enables the enrichment process to be carried out particularly efficiently and with little effort.

For the purpose of dissolving the alkali metal in the electrolyte, various agents are conceivable. For example, the alkali metal can be “passively” oxidized, for example by the electrolyte and/or a gas flowing thereon. The electrolyte and/or the gas in this case expediently comprises an oxidizing agent, or forms an oxidizing agent.

Alternatively or in addition, the alkali metal can also be dissolved “actively” in the electrolyte. For example, the alkali metal can be electrochemically oxidized, for example by contacting it with an electrode connected as an anode.

Preferred embodiments of the invention and further developments thereof are described below. Unless expressly excluded, these embodiments can be arbitrarily combined with each other and with the aspects of the invention described below.

In a preferred embodiment, the electrolyte comprises a partner substance for interacting with the alkali metal. Expediently, the alkali metal disposed in the reservoir vessel is at least partially oxidized with the aid of the partner substance and dissolved in the electrolyte. The partner substance may be part of the electrolyte, in particular a conductive salt of the electrolyte, or a separate substance which has been or is added to the electrolyte—preferably substantially as a one-off. In this respect, the use of a partner substance enables a particularly low-cost “passive” oxidation of the alkali metal.

The partner substance is expediently a redox-active partner substance and is preferably oxidized during the electrochemical deposition of the alkali metal on the anode. The oxidized partner substance can then dissolve the alkali metal in the reservoir vessel by oxidation, whereby the partner substance is expediently reduced again. In this respect, no alkali metal compounds, in particular no salts comprising the alkali metal, need to be actively added or topped up in the electrolyte during the enrichment process. In particular, the electrolyte is not “consumed” by the enrichment process.

An organic partner substance is, or is preferably, used as partner substance, in particular mixed with the electrolyte. Such organic partner substances, in particular residues thereof remaining on the substrate after the enrichment process, are generally compatible with conventional lithium batteries or at least easy to remove. If, for example, the alkali metal is embedded into the substrate, for example in coatings such as active materials on a film, there is a high probability that residues of the partner substance remain on the substrate, in particular that they are also embedded. This can occur to a greater extent if the coatings have porous structures and the alkali metal is introduced into these porous structures. If the residues of the partner substance are compatible with the type of battery concerned in each individual case, these residues can simply be left on the substrate. If, in contrast, there is incompatibility, these residues are preferably at least partially removed. Rinsing and/or evaporation steps have proven their worth in practice.

Organic substances which can simultaneously exhibit a highly reversible oxidizability and an oxidation potential in the oxidation/reduction step, which is higher than the oxidation potential for the alkali metal are, for example, metallocenes such as ferrocene (C₁₀H₁₀Fe) or cobaltocene (C₁₂H₁₀Co), dihydrophenazine (C₁₂H₁₀N₂), dimethoxybenzene (C₈H₁₀O₂), thianthrene (C₁₂H₈S₂), triphenylamine (C₁₈H₁₅N), PFPTFBB (C₁₂O₂F₁₀B), benzophenone (C₁₃H₁₀O), 1,3-benzodioxole (C₇H₆O₂), DBTFB (C₁₈H₂₄O₂F₆), phenothiazine (C₁₂H₉NS), TEMPO (C₉H₁₈NO) and all derivatives of these substances. In this respect, it is preferred that the partner substance used, i.e. added to the electrolyte, is at least one element from the group consisting of metallocenes, dihydrophenazine, dimethoxybenzene, thiantlurene, PFPTFBB, benzophenone, 1,3-benzodioxole, 1,3-di-tert-butyl-2,5-bis(2,2,2-trifluoroeth-oxy)benzene, phenothiazine, TEMPO and the derivatives of said substances. In particular, DBBB (C₂₀H₃₄O₄) or DMMB (C₁₈H₃₀O₃) as derivatives of dimethoxybenzene (DMB) or the metallocenes ferrocene or cobaltocene may be used, i.e. added to the electrolyte.

In this case, when using ferrocene, the electrolyte expediently comprises ethylene carbonate (C₃H₄O₃) and/or dimethyl carbonate (C₃H₆O₃). Ferrocene exhibits good solubility in each of the two substances. The oxidation potential of ferrocene compared to lithium as an alkali metal can thus be 3.2-3.3 V.

When using DBBB (2,5-di-tert-butyl-1,4-bis(2-methoxyeth-oxy)benzene), the electrolyte expediently comprises propylene carbonate (C₄H₆O₃). DBBB exhibits good solubility therein. The oxidation potential of DBBB compared to lithium as an alkali metal can thus be 3.8-4 V.

When using DMMB (1,4-di-tert-butyl-2-methoxy-5-(2-methoxy-ethoxy)benzene), the electrolyte expediently comprises ethylene carbonate, ethylene methyl carbonate (C₄H₈O₃) or propylene carbonate. DMMB has good solubility in each of these substances. The oxidation potential of DMMB compared to lithium as an alkali metal can thus be about 3.9 V.

When using TEMPO (2,2,6,6-tetramethylpiperidine 1-oxide), the electrolyte expediently comprises ethylene carbonate, propylene carbonate and/or ethylene methyl carbonate. TEMPO has good solubility in each of these substances. The oxidation potential of TEMPO compared to lithium as an alkali metal can thus be about 3.5 V.

By providing ethylene carbonate, dimethyl carbonate, propylene carbonate or ethylene methyl carbonate in the electrolyte, in particular as electrolyte solvent, high solubility can be ensured both in the oxidized and the reduced state of the corresponding aforementioned partner substance such as ferrocene, cobaltocene, DBBB, DMMB, benzophenone, 1,3-benzodioxole, cobaltocene, phenothiazine or TEMPO.

In a further preferred embodiment, the partner substance in the reservoir vessel, in particular during the oxidation of the alkali metal disposed in the reservoir vessel, is reduced to an extent of least 80%, preferably to an extent of at least 90%, and particularly preferably substantially completely. As a result, it can be prevented that non-reduced portions of the partner substance enter the electrolysis chamber and bring at least some of the alkali metal with which the substrate is already enriched back again into solution.

Such a degree of reduction can be achieved by providing an appropriately large alkali metal contact surface and/or by adjusting the residence time of the electrolyte or the partner substance present therein accordingly. In this respect, it may be expedient to arrange a large number of small alkali metal pellets in the reservoir vessel and/or to adjust the flow rate of the electrolyte in the reservoir vessel accordingly.

As an alternative or in addition to reduction by the alkali metal, the partner substance can also be reduced particularly reliably, in particular up to a predetermined degree, by means of a (further) electrode arranged in the reservoir vessel, which is connected as cathode.

Alternatively or in addition, the concentration of the oxidized partner substance in the electrolyte flowing onto the substrate can also be actively controlled, in particular limited, by other means. For example, the concentration of the oxidized partner substance on the substrate can be adjusted, in particular regulated, to a predetermined concentration setpoint. For this purpose, at least some of the partner substance oxidized at the anode can be removed from the electrolysis chamber. For example, at least part of the electrolyte in which the partner substance cations are dissolved can flow out of the electrolysis chamber, in particular be suctioned off. Optionally, the oxidized partner substance present in the discharged portion of the electrolyte, or the electrolyte drained off, can be diluted in order to lower the concentration of the oxidized partner sub-stance in the electrolyte drained off from the electrolysis chamber. In particular, the discharged portion of the electrolyte can be guided through the reservoir vessel and the partner substance in the reservoir vessel, particularly at an electrode connected as cathode, can be reduced. The electrolyte can then be fed back to the electrolysis chamber, in particular flowing towards the substrate.

In another preferred embodiment, the partner substance is present in a conductive salt dissolved in the electrolyte. This has the advantage that no additional substance needs to be added to the electrolyte. In this respect, the separation process can be carried out in this way in a particularly cost-effective manner. It is conceivable that the conductive salt used is a salt which provides organic ions, chloride ions (Cl—), nitrate ions (NO₃—), perchlorate ions (ClO₄—) or ozonide ions (O₃²—) when dissolved in the electrolyte. For example, lithium chloride (LiCl), lithium nitrate (LiNO₃), lithium perchlorate (LiClO₄) or lithium ozonide (LiO₃) may be used as conductive salt.

In principle, there is a risk of passivation of the alkali metal disposed in the reservoir vessel through contact with the electrolyte, in particular a solvent present in the electrolyte. However, such passivation can adversely affect the interaction of the partner substance with the alkali metal. Therefore, in a further preferred embodiment, the alkali metal disposed in the reservoir vessel is treated electrochemically. In particular, a voltage can be applied between at least two electrodes arranged in the reservoir vessel. Such electrochemical treatment of the alkali metal can prevent passivation of the alkali metal disposed in the reservoir vessel or at least passivation can be counter-acted.

In this case, it is particularly advantageous if alkali metal, especially inhibited alkali metal, i.e. the reaction of which with the electrolyte is inhibited, for example by passivation, is dissolved in the electrolyte by electrochemical treatment. In other words, in addition to the oxidation-induced (i.e. caused by the partner substance) dissolution of alkali metal ions in the electrolyte, alkali metal ions are preferably also dissolved electrochemically. The surface of the alkali metal disposed in the reservoir vessel can be kept free of a passivated layer by means of the, preferably continuous, electrochemical displacement of material. For example, a layer on the surface of, for example, alkali metal pellets can be dissolved in the electrolyte before passivation of the surface can occur or progress. In this respect, the electrochemical dissolution of alkali metal allows the surface of the alkali metal disposed in the reservoir vessel to be “kept fresh” and thus enables continuously high oxidizability with the aid of the partner substance.

In this respect, it is also advantageous if alkali metal dissolved in the electrolyte by the electrochemical treatment, i.e. alkali metal ions, is at least partially deposited again in the reservoir vessel. This also allows the surface of the alkali metal disposed in the reservoir vessel to be kept free of a passivated layer. In particular, the inhibited alkali metal, for example, can be dissolved in a first region of the reservoir vessel and be deposited again in a second region. In other words, the electrochemical treatment preferably involves a kind of “rearrangement” of the alkali metal disposed in the reservoir vessel. Therefore, at least substantially the entire surface of the alkali metal is permanently available for reduction with the aid of the partner substance.

For example, the alkali metal in the reservoir vessel can be brought into contact with or be in contact with an electrode in order to dissolve the alkali metal in the electrolyte by the flow of an oxidation current. The position of this electrode in the reservoir vessel can define the first region. This electrode is expediently connected as an anode, i.e. connected to the positive pole of a corresponding current or voltage source. The anodic circuit of this electrode can also protect the partner substance from unwanted reduction beyond the basic form. This is particularly advantageous when using DBBB or DMMB as a partner substance.

This electrode preferably consists at least partially of a noble metal, for example copper, gold, silver or platinum, in order to ensure long-lasting chemical stability in the electrolyte and/or on contact with the alkali metal. In this respect, it is particularly advantageous if the electrode consists of a metal that does not form an alloy with the alkali metal. If lithium is used as alkali metal, the electrode may, for example, consist at least partially of copper.

Alternatively or in addition, “passive” oxidation of the alkali metal in the reservoir vessel is also possible. In order to catalyze the dissolution of the alkali metal, it is possible to provide or generate local elements in the reservoir vessel by producing a conductive compound of the alkali metal with a noble metal, for example copper or platinum, or at least to enable, in particular to promote, the formation thereof. Particularly advantageously for this purpose, a cage or basket in which the alkali metal can be or is disposed in the reservoir vessel, in particular in the form of a bed of alkali metal pellets, may be made of the noble metal. The provision or formation of local elements in the reservoir vessel makes it possible to dispense with a dedicated electrode for oxidizing the alkali metal. Consequently, no corresponding power source is required to apply a voltage to the electrode.

The targeted deposition of the dissolved alkali metal in the reservoir vessel may be achieved using a further electrode. The position of this additional electrode in the reservoir vessel can define the second region. This further electrode is expediently connected as cathode, i.e. connected to the negative pole of the corresponding current or voltage source.

The further electrode is preferably arranged in the reservoir vessel downstream—based on the flow direction of the electrolyte—of at least a portion of the alkali metal, in particular downstream of the first and/or second region. In this case, the further electrode can be brought into con-tact or be in contact with the alkali metal in the reservoir vessel, for example, may be or is arranged within a bed. In order to achieve deposition of the alkali metal dissolved in the electrolyte, for example by means of the electrode operated as anode, on the further electrode or on alkali metal brought into contact therewith, the electrolyte expediently flows against the further electrode.

The further electrode may optionally be arranged in a section of the reservoir vessel in which no alkali metal is or may be disposed. The further electrode may be arranged in particular—based on the flow direction of the electrolyte—upstream of the alkali metal in the reservoir vessel. In this case, the partner substance can be reduced on this electrode operated as cathode and not by oxidation of the alkali metal. This arrangement prevents the alkali metal electrochemically dissolved in the reservoir vessel from being deposited on the further electrode. In this respect, with the aid of this arrangement of the further electrode, electrochemically dissolved alkali metal can be made avail-able for the enrichment of the substrate. This can provide better control over the concentration of lithium ions dissolved in the electrolyte.

If the electrolyte comprises the partner substance, this partner substance (previously oxidized at the anode in the electrolysis chamber) can be at least partially reduced at the further electrode arranged upstream of the alkali metal in the reservoir vessel. This reliably prevents the partner substance from dissolving already deposited or embedded alkali metal when flowing onto the substrate in the electrolysis chamber. At the same time, the partner substance thus reduced at the further electrode can be re-oxidized at the anode in the electrolysis chamber.

The progressive dissolution of the alkali metal and/or corresponding recharging may result in partial slipping or floating of a bed of the alkali metal in the reservoir vessel. As a result, there is the risk of a short circuit between the electrodes. In practice, the electrolyte in the reservoir vessel can therefore be guided through a separator, such as a plastic sieve, between the two electrodes. Such a separator has proven to be an effective means of preventing a short circuit between the electrodes. The separator may be provided, for example, in a cage or basket in which the alkali metal is disposed or can be disposed. In particular, the separator can divide such a cage or basket. The cage or basket must also be electrically insulating, for example made of plastic. Alternatively, the alkali metal can be disposed in two electrically separated cages or baskets that are appropriately spaced apart.

If the further electrode connected as cathode is not in contact with the alkali metal, a cage or basket filled with or fillable with the alkali metal is sufficient. The separator can be dispensed with in this case.

In a further preferred embodiment, a gas that oxidizes the alkali metal is introduced into the reservoir vessel to dissolve the alkali metal disposed in the reservoir vessel in the electrolyte or—based on the flow direction of the electrolyte—is dissolved in the electrolyte upstream of the reservoir vessel. This enables a particularly reliable oxidation of the alkali metal. If, for example, the alkali metal is disposed in the form of pellets in the reservoir vessel, the gas can be easily fed through the corresponding bed and a correspondingly large surface area of the pellets, essentially the entire surface area, can be oxidized. In this respect, the gas can be used to dissolve large amounts of the alkali metal in the electrolyte.

The gas can be dissolved in the electrolyte when the gas is introduced into the reservoir vessel, especially during oxidation of the alkali metal, but optionally also upstream of the reservoir vessel. Preferably, the gas dissolved in the electrolyte at least partially forms a conductive salt of the electrolyte, particularly together with the dissolved alkali metal.

Nitrous gases have proven to be an effective oxidizing agent for alkali metals, especially lithium. In this respect, it is preferable if a nitrous gas is introduced into the reservoir vessel. It is conceivable, for example, to introduce NO₃ into the reservoir vessel. NO₃ ions, especially NO₃ anions (NO₃—), can effect reliable oxidation of the alkali metal.

Similarly good effects regarding oxidation of the alkali metal can also be achieved with halogen gases. In this respect, it is also preferable if a halogen gas is introduced into the reservoir vessel. It is conceivable, for example, to introduce Cl₂ into the reservoir vessel. Cl₂ ions, especially Cl₂ anions (Cl₂—), can also effect reliable oxidation of the alkali metal.

In order to carry out a largely closed enrichment process or to operate a largely closed system, it is preferable to integrate the generation of the gas to be introduced into the reservoir vessel into the enrichment process. In a preferred embodiment, the gas is therefore generated at an anode in the electrolysis chamber. This eliminates the need for a dedicated gas source, i.e. makes an external gas sup-ply superfluous and thus reduces the consumables required for the enrichment process.

Preferably, the gas is generated from the conductive salt dissolved in the electrolyte. In particular, at least one constituent of the conductive salt can be oxidized at the anode. Expediently, this oxidized constituent of the conductive salt is converted to the gaseous state. The resulting gas can be collected and conducted into the reservoir vessel by suitable means, for example a gas line and/or gas pump, in order to be reduced again on the alkali metal and dissolved in the electrolyte. In this respect, at least one constituent of the conductive salt may be part of a gas circuit for dissolving the alkali metal in the electrolyte.

A second aspect of the invention relates to a method for enriching a substrate with an alkali metal, in particular lithium, wherein an electrolyte is guided, in particular in a circuit, through an electrolysis chamber having an anode and a cathode. An alkali metal is expediently dissolved in the electrolyte, i.e. the electrolyte preferably comprises (positively charged) ions of the alkali metal. Expediently, a substrate used as cathode in the electrolysis chamber is enriched with the dissolved alkali metal, in particular by reducing the alkali metal ions. It is preferred that the electrolyte comprises a protective substance which is oxidized at the anode and is reduced only in one or more pre-determined sections on the substrate. It is thus advantageously possible to prevent the substrate from being enriched with alkali metal in one or more predetermined sections. In other words, the one or more predetermined sections can be kept free of alkali metal. In this respect, the enrichment of the substrate can be spatially con-trolled.

In this context, the protective substance may be suitable for the purpose of limiting the enrichment to an active material of the substrate. If, for example, the substrate comprises an active material on a conductor or metal foil, for example a copper foil, into which the alkali metal is or is to be embedded, the protective substance can be used to prevent alkali metal from also being deposited on the conductor foil when alkali metal is embedded in the active material, or the extent of the deposition can at least be significantly reduced. For this purpose, the protective substance is oxidized at the anode and reduced in only a predetermined section on the substrate, for example directly on the conductor foil. The reduction in the predetermined section can prevent the alkali metal from also being reduced in this section and depositing on the substrate.

The method according to the second aspect of the invention may stand alone. However, it is in principle also compatible with the method according to the first aspect of the invention. In this respect, the method according to the second aspect of the invention may be combined with the method according to the first aspect of the invention. In a further preferred embodiment of the method according to the first aspect of the invention, the electrolyte thus comprises the protective substance which is oxidized at the anode and reduced only in one or more predetermined sections on the substrate.

This protective substance, which can be reversibly oxidized at the anode and reduced on the substrate, can be used, for example, to prevent lithium from being deposited on bare copper regions, which is highly undesirable, in a copper foil that is not fully covered with an active material. In this case, the bare copper region corresponds to the predetermined section. The protective substance is expediently selected such that it is reduced on the substrate before deposition with the alkali metal can take place there.

In order to ensure the protective function of the protective substance on the substrate, in particular reduction thereof on the substrate, it is preferable that the partner substance oxidized at the anode is at least partially supplied directly to the substrate. For example, at least part of the electrolyte with the oxidized protective substance present therein can be discharged from the electrolysis chamber downstream of the anode—based on the flow direction of the electrolyte—and fed directly to the substrate, i.e. upstream of the substrate, back into the electrolysis chamber. A direct (re)cycling to the substrate means routing without additional processing of the electrolyte and substances present/dissolved therein, i.e. without purification or reprocessing steps and/or the like. For efficient and reliable protection of the predetermined section, it may also be advantageous to actively control the concentration of cations of the protective substance in the electrolyte flowing onto the substrate, for example by (only) supplying a predetermined portion of the electrolyte with the protective substance present therein directly to the substrate. The remaining part of the electrolyte can be processed however, for example the protective substance in the reservoir vessel can be reduced on a cathodically connected electrode. When necessary, an excessively high cation concentration on the substrate can be prevented.

A protective substance added to the electrolyte, which is repeatedly oxidized and reduced on the substrate, can lead to a leakage current, thereby reducing the efficiency of the enrichment process. To counteract this, the protective substance is selected such that the oxidation potential thereof is, on the one hand, sufficient to oxidize and thus to dissolve the alkali metal, in particular lithium, deposited on the substrate in the one or more predetermined regions, in particular directly on the metal foil, but on the other hand not to oxidize alkali metal which is embedded in the substrate in at least one section different from the one or more predetermined sections, in particular in an active material of the substrate. Such an oxidation potential can be achieved by selecting a specific derivative or by adapting residual groups of the protective substance. The “suitable” oxidation potential—and thus the “suitable” protective substance—is expediently selected depending on the substrate material and/or an active material of the substrate, in particular the substrate material in the one or more predetermined sections and/or in the at least one section different from the one or more predetermined sections.

Alternatively or in addition, the protective substance is deposited in the one or more predetermined sections of the substrate, but not in the at least one section of the substrate different from the one or more predetermined sections. By depositing on the substrate, in particular on the conductor foil, the protective substance can provide targeted protection against deposition of the alkali metal there. For this purpose, the protective substance can be selected such that it is preferably reduced on the material of the substrate in the one or more predetermined sections. This can be achieved, for example, by the redox potential difference between the protective substance and a first substrate material in the one or more predetermined sections, for example the material of a conductor foil such as copper, being greater than between the protective substance and a second substrate material in the at least one section different from the one or more predetermined sections, for example an active material. Alternatively or in addition, the reduction of the protective substance in the at least one section different from the one or more predetermined sections can be kinetically inhibited and/or the reduction on the substrate material in the one or more predetermined sections can be catalytically favored.

If, for example, a copper foil is not coated with an active material over its surface and lithium is to be embedded in the active material, the protective substance can be selected such that the reduction potential thereof is sufficient for reduction directly on the copper foil, but not for deposition or embedding the protective substance on or in the active material. The one or more predetermined sections correspond in this case to the pure copper surface and the at least one section different from the one or more predetermined sections corresponds to the active material surface.

Protective substances having suitable redox potentials, particularly with regard to the enrichment of a copper-containing substrate with lithium, include, inter alia, metallocenes such as ferrocene (C₁₀H₁₀Fe) or cobaltocene (C₁₂H₁₀Co), dihydrophenazine (C₁₂H₁₀N₂), thianthrene (C₁₂H₈S₂), triphenylamine (C₁₈H₁₅N), PFPTFBB ( ), benzophenone (C₁₃H₁₀O), 1,3-benzodioxole (C₇H₆O₂), DBTFB (C₁₈H₂₄O₂F₆), phenothiazine (C₁₂H₉NS), TEMPO (C₉H₁₈NO) and all derivatives of said sub-stances. In this respect, it is preferred that a substance from a group of protective substances is added to the electrolyte, wherein the group comprises metallocenes, dihydro-phenazine, thiantlurene, triphenylamine, PFPTFBB, benzophenone, 1,3-benzodioxole, 1,3-di-tert-butyl-2,5-bis(2,2,2-trifluoroethoxy)benzene, phenothiazine, TEMPO and all derivatives of said substances.

It has been found that DBBB and DMMB can be irreversibly reduced on at least one alkali metal, namely lithium, at least under certain conditions. In this respect, additional precautions may have to be taken for the use of DBBB and DMMB as protective substance. For example, the protective substance or the partner substance can be added to the electrolyte during the enrichment process substantially continuously and the reduced constituents filtered out. Another possibility to prevent or at least reduce the irreversible reduction of DBBB or DMMB on, for example, lithium in the reservoir vessel—if present—is to anodize the electrode located there—and thus the alkali metal in contact with the electrode. In this case, the electrode connected as cathode is preferably arranged downstream of the alkali metal in the reservoir vessel in order to reduce the contact between already reduced DBBB or DMMB and the alkali metal.

It is preferable that the protective substance corresponds to the partner substance. In this case, the partner substance can therefore undertake the task of the protective substance. In other words, when using in particular metallocene, dihydrophenazine, thiantlurene, triphenylamine, PFPTFBB, benzophenone, 1,3-benzodioxole, 1,3-di-tert-butyl-2,5-bis(2,2,2-trifluoroethoxy)benzene, phenothiazine, TEMPO and all derivatives of said substances as partner sub-stance, it may not be necessary to add a dedicated protective substance to the electrolyte.

In order to ensure the protective effect of the partner substance on the substrate in this case, it is preferable that the partner substance is reduced to an extent of at most 90%, preferably to an extent of at most 80%, particularly preferably to an extent of at most 70%, during oxidation in the reservoir vessel, for example by the alkali metal disposed therein or a cathodically connected electrode arranged therein. This can be achieved, for example, by an appropriately selected run time, i.e., for example, by setting the pumping device accordingly, and/or by the appropriate dimensioning of the alkali metal surface to which the flow is directed, i.e., for example, by selecting correspondingly large alkali metal pellets. This prevents the partner substance from being completely reduced on the alkali metal in the reservoir vessel, so that the remaining concentration of the oxidized partner substance in the electrolyte is sufficient for the protective effect on the substrate.

In a further preferred embodiment, the anode is inert with respect to the electrolyte—and any substances dissolved therein. Expediently, the anode is inert with respect to the partner substance, the protective substance and/or a conductive salt of the electrolyte. As a result, an anion of an alkali metal salt, for example, can be oxidized during the enrichment process without degrading the anode and thus changing the field distribution in the electrolysis chamber, which could lead to an inhomogeneous enrichment of the substrate.

For example, the anode may comprise a noble metal, preferably platinum or copper. In particular, the anode can be made from the noble metal. This favors the oxidation of the partner substance at the anode.

The method according to the first and/or second aspect of the invention can be advantageously used in the electrochemical deposition of metal layers, in particular in anhydrous organic solvents. It has proved particularly effective in the deposition of lithium. It can also be used advantageously in the production of alkali metal electrodes, in particular anodes, for alkali metal batteries, wherein lithium is advantageously provided as alkali metal. The method has also proved its worth in the enrichment of negative electrodes for rechargeable batteries with an alkali metal, especially in the enrichment of negative electrodes for lithium-ion batteries with lithium.

In this respect, according to a third aspect of the invention, a substrate enriched using the method according to the first and/or second aspect of the invention is used as electrode in a battery. In particular, applications in a lithium-ion battery or a lithium metal battery are conceivable.

A device according to a fourth aspect of the invention for enriching a substrate with an alkali metal, in particular lithium, comprises an electrolysis chamber having an anode.

In addition, a substrate to be enriched with an alkali metal is or can be arranged as cathode in the electrolysis chamber. In addition, the device has a reservoir vessel in which the alkali metal is or can be disposed, and an agent for oxidizing the alkali metal disposed in the reservoir vessel. In addition, a pumping device is preferably pro-vided in order to guide an electrolyte in a circuit through the electrolysis chamber and the reservoir vessel, so that alkali metal oxidized in the reservoir vessel with the aid of the agent and thereby dissolved in the electrolyte is provided in the electrolysis chamber and the substrate used as cathode is enriched with the dissolved alkali metal. This device can be used, for example, to deposit lithium on a copper foil or to embed it in an active material on such a foil. By providing the alkali metal, for example in the form of pellets, in the reservoir vessel, in contrast to the operation of conventional systems, neither a conductive salt of the electrolyte is consumed, nor must the anode be designed as an alkali metal dispenser, i.e. detachable. In this respect, the device according to the invention offers more freedom in the design of the anode geometry. In particular, a thin inert anode can be used. There are also fewer restrictions regarding the flow design in the electrolysis chamber in order to achieve homogeneous enrichment with the alkali metal.

In a preferred embodiment, the agent for oxidizing the alkali metal disposed in the reservoir vessel comprises a partner substance mixed with the electrolyte, an electrode arranged in the reservoir vessel, in particular an electrode which can be brought into contact or is in contact with the alkali metal, and/or a gas supply for introducing a gas oxidizing the alkali metal into the reservoir vessel or dissolving the gas in the electrolyte upstream of the reservoir vessel. The agent for oxidizing the alkali metal may comprise further components or units, such as a dedicated gas pump, gas line, further electrode in the reservoir vessel, current or voltage source to the reservoir vessel and/or the like. Such an agent for oxidizing the alkali metal can ensure that a sufficient amount of alkali metal is dissolved in the electrolyte for effective enrichment of the substrate and/or at least prevent a substantial passivation of the alkali metal disposed or that can be disposed in the reservoir vessel.

In another preferred embodiment, a first reservoir vessel and a second reservoir vessel are provided in which the alkali metal can be or is disposed. In addition, a control device can be provided, which is designed to guide the electrolyte through the first and second reservoir vessels in such a way that during recharging of the alkali metal in the first reservoir vessel, the electrolyte flows predominantly, preferably essentially exclusively, through the second reservoir vessel and that during recharging of the alkali metal in the second reservoir vessel, the electrolyte flows predominantly, preferably essentially exclusively, through the first reservoir vessel. This allows the alkali metal to be recharged without interrupting the operation of the device, i.e. the deposition process. This is particularly advantageous when used in roll-to-roll processes, as the deposition is intended to be essentially continuous onto a belt running through the electrolysis chamber.

In order to further facilitate operation of the device, the control device is preferably also set up to fill the first reservoir vessel and the second reservoir vessel with the alkali metal as required, in particular to refill them. In other words, the control device may be set up for automatic recharging. Preferably, an alkali metal depot is provided for this purpose, from which the control device can remove alkali metal and feed it to the first and the second reservoir vessels.

A device according to a fifth aspect of the invention for enriching a substrate with an alkali metal, in particular lithium, comprises an electrolysis chamber having an anode. In addition, a substrate to be enriched with an alkali metal is or can be arranged as cathode in the electrolysis chamber. Expediently, the device comprises an electrolyte in which an alkali metal is dissolved and which comprises a protective substance. Preferably, a pumping device is also provided for guiding the electrolyte in a circuit through the electrolysis chamber, so that alkali metal dissolved in the electrolyte is provided in the electrolysis chamber and the substrate used as cathode is enriched with the dissolved alkali metal and the protective substance present in the electrolyte is oxidized at the anode and is reduced only in one or more predetermined sections on the substrate. This device can be used, for example, to deposit lithium on a copper foil or to embed it in an active material on such a foil. By means of guiding the electrolyte comprising the protective substance, it is possible to prevent the substrate from being enriched with the alkali substrate in certain critical regions, for example at contact points.

A sixth aspect of the invention relates to an electrolyte, in particular for use in a method according to the first or second aspect of the invention, comprising a partner substance which is oxidizable at an anode and which can be reduced at an alkali metal, and the electrolyte is constituted to dissolve the alkali metal by oxidation with the aid of the oxidized partner substance.

A seventh aspect of the invention relates to an electrolyte, in particular for use in a method according to the first or second aspect of the invention, in which an alkali metal is dissolved and which comprises a protective substance which is oxidizable at an anode and which can be reduced on a substrate used as cathode only in one or more predetermined sections, so that the substrate cannot be enriched with the alkali metal dissolved in the electrolyte in the one or more predetermined sections.

The invention is elucidated in more detail below with the aid of figures. Where appropriate, elements having the same function are given the same reference numeral. The invention is not limited to the working examples depicted in the figures, including in respect of functional features. The description up to now and the figure descriptions that follow contain numerous features that in some cases are combined into more than one in the dependent subsidiary claims. However, those skilled in the art will also consider these features, and all other features disclosed above and in the following description of the figures, individually and combine them into useful further combinations. In particular, all said features may be combined individually and in any suitable combination with the method according to the first aspect of the invention, the method according to the second aspect of the invention, the use according to the third aspect of the invention, the device according to the fourth aspect of the invention, the device according to the fifth aspect of the invention, the electrolyte according to the sixth aspect of the invention and the electrolyte according to the seventh aspect of the invention.

Shown, at least partially schematically:

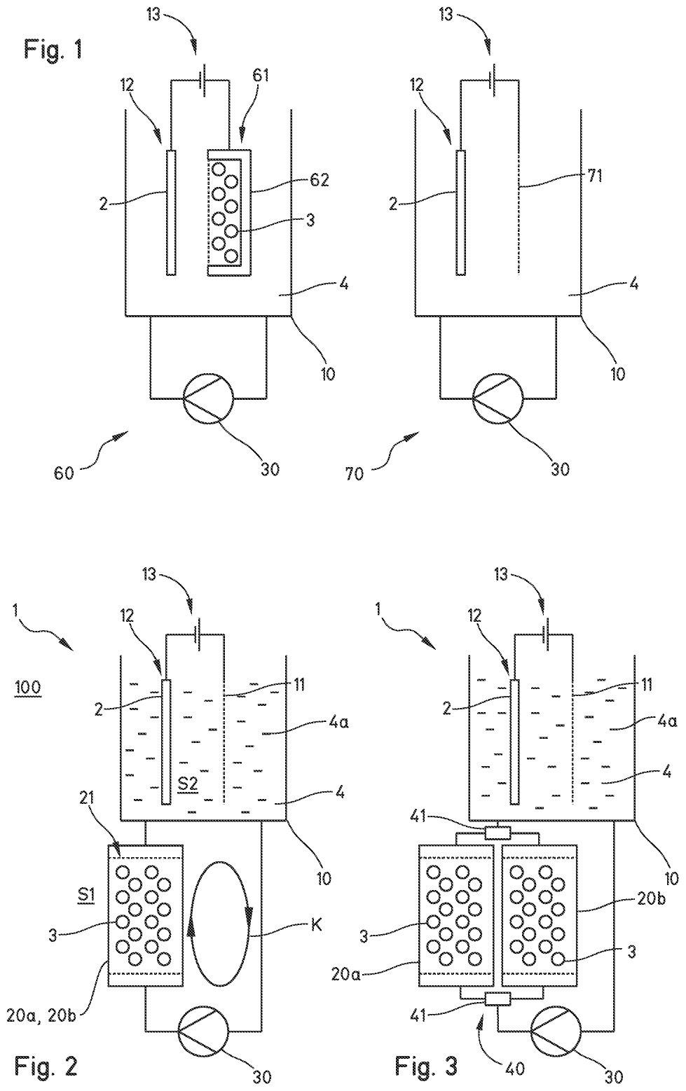

FIG. 1 Two devices from the prior art for enriching a substrate with an alkali metal;

FIG. 2 An example of a method and a device for enriching a substrate with an alkali metal kept in a reservoir vessel;

FIG. 3 An example of a device having a first and a second reservoir vessel;

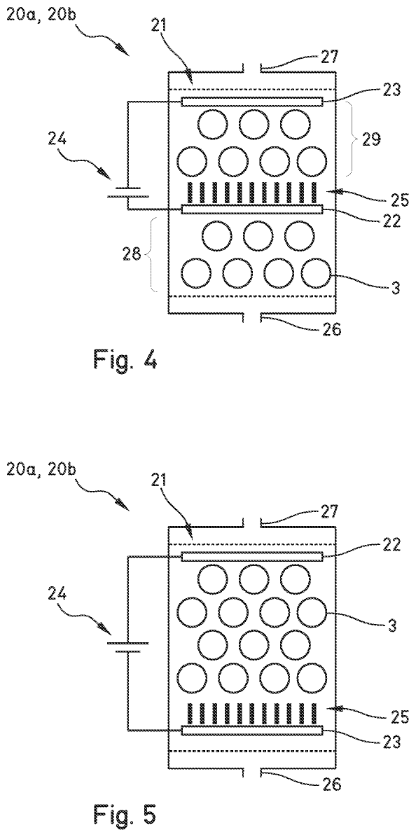

FIG. 4 An example of a reservoir vessel;

FIG. 5 A further example of a reservoir vessel;

FIG. 6 An example of a gas supply for a reservoir vessel; and

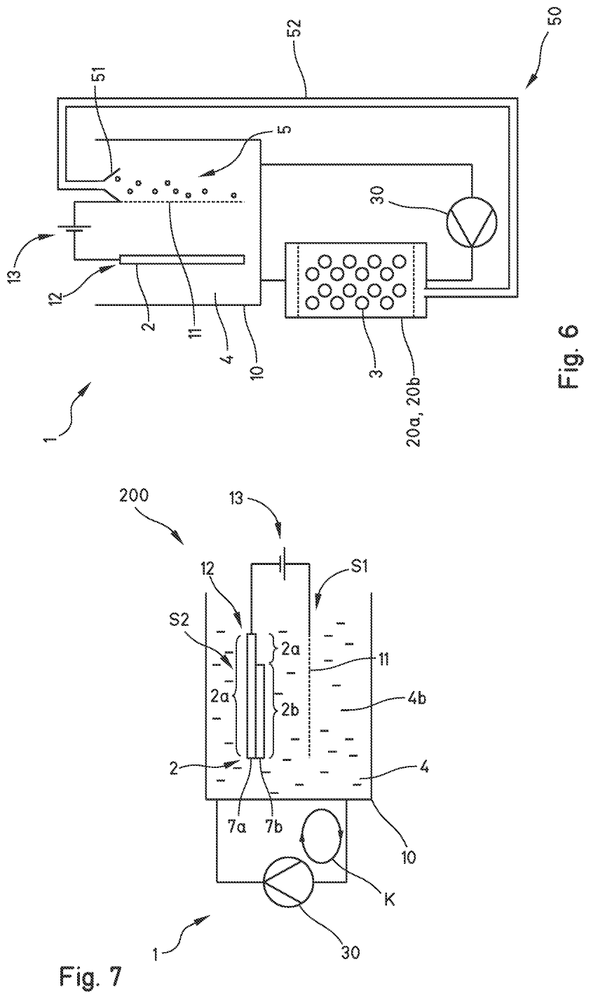

FIG. 7 An example of a method and a device for enriching a substrate with an alkali metal with the aid of a protective substance.

FIG. 1 shows two devices 60, 70 from the prior art for enriching a substrate 2 with an alkali metal 3.

The device 60 shown on the left comprises an electrolysis chamber 10 having a soluble anode 61 and a cathode 12, which is formed by the substrate 2 to be enriched. The anode 61 comprises a cage 62 in which the alkali metal 3 is kept in the solid state, for example in the form of pellets. The electrolysis chamber 10 is filled with an electrolyte 4, which can be recirculated by means of a pump device 30 for the purpose of reprocessing (not shown). The electrolyte 4 expediently comprises a solvent and an alkali metal-containing salt, which is also referred to as the conductive salt.

When applying a voltage between the anode 61 and the cathode 12 by means of a current or voltage source 13, the alkali metal cations of the conductive salt dissolved in the electrolyte 4 are deposited on the substrate 2 or embedded in the substrate 2, with uptake of an electron. The cation concentration in the electrolyte 4 remains essentially constant, since the alkali metal 3 in the cage 62 oxidizes, releasing alkali metal cations into the electrolyte 4. The alkali metal 3 in the cage 62 consequently dissolves in the course of the deposition process. In this respect, the anode 61 is soluble, so that with time a complete replacement of the anode 61 or at least a costly recharging of alkali metal 3 in the cage 62 is necessary.

The device 70 shown on the right is designed in the same way. It differs from the device 60 only by the use of an inert anode 71.

When applying a voltage between the anode 71 and the cathode 12 by means of the current or voltage source 13, the alkali metal cations of the conductive salt dissolved in the electrolyte 4 are deposited on the substrate 2 or embedded in the substrate 2. Since the cation concentration in the electrolyte 4 decreases as a result, conductive salt must be recharged. At the same time, constituents of the conductive salt that oxidize at the anode 71 may potentially have to be laboriously separated from the electrolyte 4.

FIG. 2 shows an example of a method 100 and a device 1 for enriching a substrate 2 with an alkali metal 3 kept in a reservoir vessel 20a, 20b. In addition to the reservoir vessel 20a, 20b for holding the alkali metal 3, the device 1 comprises an electrolysis chamber 10 and a pumping device 30, which is expediently connected to the electrolysis chamber 10 and the reservoir vessel 20a, 20b in a fluid-conducting manner. The reservoir vessel 20a, 20b is preferably designed separately from the electrolysis chamber 10, i.e. arranged outside the electrolysis chamber 10. The electrolysis chamber 10 comprises an anode 11 and is set up to retain the substrate 2 as cathode 12. The anode 11 is expediently connected to the positive pole of a current or voltage source 13. The negative pole of the current or voltage source 13, on the other hand, can be connectable or connected to the substrate 2, i.e. the cathode 12.

The electrolysis chamber 10 is expediently filled or can be filled with an electrolyte 4, in which preferably a partner substance 4a is dissolved or is soluble, for interacting with an alkali metal 3 that is disposed or can be disposed in the reservoir vessel 20a, 20b. This partner substance 4a may be a conductive salt of the electrolyte 4 or at least one constituent thereof, wherein the conductive salt is expediently a salt of the alkali metal 3. Conductive salts conceivable for use in conjunction with, for example, lithium as alkali metal 3, are in this respect LiCl, LiClO₄, LiNO₃ and/or the like. These lithium salts may be dissolved, for example, in propylene carbonate (C₄H₆O₃), ethylene carbonate (C₃H₄O₃), dimethyl carbonate (C₃H₆O₃), gamma-butyro-lactone (C₄H₆O₂), diethyl carbonate (C₅H₁₀O₃), dimethyl ether (C₂H₆O), 1-2 dioxolane (C₃H₆O₂), ethylene methyl carbonate (C₄H₈O₃) and/or the like.

Alternatively, however, an additional partner substance 4a is also conceivable, which is mixed or miscible with the electrolyte 4. Conceivable here are ferrocene (C₁₀H₁₀Fe), DBBB (C₂₀H₃₄O₄), DMMB (C₁₈H₃₀O₂) and TEMPO (C₉H₁₈NO). Also conceivable are cobaltocene (C₁₂H₁₀Co) or another metallocene, dihydrophenazine (C₁₂H₁₀N₂), dimethoxybenzene (C₈H₁₀O₂), thianthrene (C₁₂H₈S₂), triphenylamine (C₁₈H₁₅N), PFPTFBB (C₁₂O₂F₁₀B), benzophenone (C₁₃H₁₀O), 1,3-benzodioxole (C₇H₆O₂), DBTFB (C₁₈H₂₄O₂F₆), phenothiazine (C₁₂H₉NS), and all derivatives of these and the substances cited above. These may be dissolved in at least one of the solvents already mentioned. As conductive salt, LiPF₆ or LiTFSi are also possible with an additional partner substance 4a.

In the method 100, the electrolyte 4 is guided in a circuit K through the electrolysis chamber 10 and the reservoir vessel 20a, 20b, expediently with the aid of the pump device 30. In a method step S1, alkali metal 3 disposed in the reservoir vessel 20a, 20b is dissolved by oxidation in electrolyte 4 with the aid of the partner substance 4a. In a method step S2, the substrate 2 used as cathode 12 is then enriched with the dissolved alkali metal 3.

During oxidation of alkali metal 3 in method step S1, cations in particular are dissolved in electrolyte 4. These dissolved alkali metal cations can be pumped into the electrolysis chamber 10 together with the electrolyte 4 by means of the pumping device 30. Expediently, the alkali metal cations then accept electrons at the cathode 12 in method step S2. The alkali metal atoms, that are therefore neutral again, are deposited on the substrate 2, such as a metal foil (so-called “plating”) or embedded in the substrate 2, in particular an active material applied to a metal foil (so-called “prelithiation”).

If, for example, the substrate 2 is to be enriched with lithium (Li), the following reaction can take place in method step S1 in the reservoir vessel 20a, 20b:

Li(s)+[X]⁺→[X]+Li⁺(solv),

where [X] is the partner substance 4a and (s) represents “solid”, and (solv) represents “solvent”, i.e. dissolved. The partner substance 4a, which acts as oxidizing agent, is thereby reduced.

At the cathode 12, the following reaction preferably then proceeds in method step S2:

Li⁺(solv)+e⁻→Li(s).

In order to be able to replace the lithium deposited or embedded in this way by re-oxidation of the alkali metal 3 in the reservoir vessel 20a, 20b, the partner substance 4a is expediently oxidized at the anode 11:

[X](solv)→[X]⁺+e⁻.

In order to prevent the partner substance 4a oxidized at the anode 11 from dissolving alkali metal 3 already deposited on the substrate 2 or embedded in the substrate 2, the flow of electrolyte 4 through the electrolysis chamber 10 is expediently selected such that electrolyte 4 flowing along the anode 11 is discharged directly into the reservoir vessel 20a, 20b. Alternatively or in addition, the electrolyte flow in the electrolysis chamber 10 can be guided plane-parallel to the anode 11 and the substrate 2. Improved separation between the resulting anolyte and catholyte region can be achieved by arranging a sieve mesh and/or the like between the anode 11 and the substrate 2. Alternatively or in addition, the electrolyte 4 can be discharged or suctioned out at different points of the electrolysis chamber 10 in such a way that there is no mixing of electrolyte streams flowing along the anode 11 or the substrate 2 in the electrolysis chamber 10.

If the electrolyte also comprises a protective substance (see FIG. 6), it is preferable to direct at least a portion of the electrolyte 4 flowing along the anode 11 specifically onto the substrate 2 in order to prevent or at least attenuate enrichment with the alkali metal 3 in one or more predetermined sections of the substrate 2.

As already indicated above, the alkali metal 3 disposed in the reservoir vessel 20a, 20b can serve as a reservoir or source for alkali metal ions dissolved in the electrolyte 4. The alkali metal 3 is disposed or can be disposed, for example, in the form of pellets in the reservoir vessel 20a, 20b. These pellets can form a bed in the reservoir vessel 20a, 20b, through which the electrolyte 4 can readily flow. Expediently, the alkali metal 3, in particular the pellets, is disposed or can be disposed in a cage, which is also occasionally referred to as filter 21, within the reservoir vessel 20a, 20b. Such a filter 21 can be easily filled with alkali metal 3 due to the separate arrangement of the reservoir vessel 20a, 20b. In other words, alkali metal 3 can be easily recharged. Optionally, the filter 21 can also be easily completely replaced.

Even if the substrate 2 is shown schematically in FIG. 2 as a classical electrode in a galvanic bath, the substrate 2 may be a section of a belt, for example a metal belt, in particular a copper belt. In a variant of the device 1 shown in FIG. 2, such a belt can be fed into the electrolysis chamber 10 and, after enrichment with the alkali metal 3, out of the electrolysis chamber 10, so that enrichment can take place in a roll-to-roll process.

FIG. 3 shows another example of a device 1 for enriching a substrate 2 with an alkali metal 3. The device 1 is constructed substantially analogously to the device shown in FIG. 2 and differs only in a second reservoir vessel 20b, which is provided in addition to a first reservoir vessel 20a, and a control device 40. The control device 40 is expediently set up to conduct the electrolyte 4 selectively through the first or second reservoir vessel 20a, 20b. For this purpose, the control device 40 may include, inter alia, a valve arrangement 41, for example having at least one two-way valve and/or two or more shut-off valves (not shown), with which feed lines to the reservoir vessels 20a, 20b can be selectively shut off if required. In addition, the control device 40 preferably has a means (not shown) of actuating the valve arrangement 41, in particular individual components or component groups thereof. For example, the control device 40 may have one or more actuators.

By means of the control device 40, during recharging of the alkali metal 3 in the first reservoir vessel 20a, electrolyte can be passed predominantly, preferably essentially exclusively, through the second reservoir vessel 20b. Correspondingly, the control device 40 can be used to pass the electrolyte 4 predominantly, preferably essentially exclusively, through the first reservoir vessel 20a, also during recharging of the alkali metal 3 in the second reservoir vessel 20b.

In order to enable automatic control of the electrolyte flow through the reservoir vessels 20a, 20b, it is expedient to also equip the control device 40 with one or more sensors (not shown). For example, the sensor(s) may be set up to detect an alkali metal level in each of the reservoir vessels 20a, 20b.

FIG. 4 shows an example of a reservoir vessel 20a, 20b for a device for enriching a substrate with an alkali metal 3. The reservoir vessel 20a, 20b expediently has an electrolyte inlet 26 and an electrolyte outlet 27, so that an electrolyte can flow through the reservoir vessel 20a, 20b. The reservoir vessel 20a, 20b is designed to accommodate the alkali metal 3 in solid form, for example in the form of pellets. For this purpose, the reservoir vessel 20a, 20b preferably has a filter 21, which can also be referred to as a cage or basket. The alkali metal 3 can be oxidized with the aid of a partner substance present in the electrolyte and is thereby dissolved in the electrolyte (see FIG. 2). In this case, the partner substance is an agent for oxidizing the alkali metal 3 in the reservoir vessel 20a, 20b.

In addition, two electrodes 22, 23 are provided, arranged in the reservoir vessel 20a, 20b, which are connected to a current or voltage source 24. The electrodes 22, 23 are separated by a separator 25.

By means of the electrodes 22, 23, the reservoir vessel 20a, 20b is advantageously designed to treat the alkali metal 3 electrochemically. In particular, alkali metal 3, in particular inhibited alkali metal 3, can be dissolved in the electrolyte with the aid of electrodes 22, 23, for example by the one electrode 22 oxidizing the alkali metal 3 that is in contact or has been brought into contact therewith. The electrode 22 is or is for this purpose expediently connected to a positive pole of the current or voltage source 24 and thus operated as an anode. In this respect, the one electrode 22 is also a means for oxidizing the alkali metal 3 in the reservoir vessel 20a, 20b.

At least some of the alkali metal 3 dissolved by the oxidation with the aid of the electrode 22 can also be deposited again in the reservoir vessel 20a, 20b. For example, the alkali metal 3 can be dissolved by the electrochemical treatment in a first region 28 and deposited again in a second region 29, which is downstream of the first region 28. In particular, alkali metal 3, which is dissolved in the electrolyte with the aid of the one electrode 22, can be deposited on the further electrode 23 and/or on alkali metal 3 that is in contact or has been brought into contact with the further electrode 23. The further electrode 23 is or is for this purpose expediently connected to a negative pole of the current or voltage source 24 and thus operated as a cathode. The further electrode 23 is preferably arranged downstream of the one electrode 22. The dissolution and separating off of alkali metal 3 by the electrodes 22, 23 can reliably prevent passivation of the surface of the alkali metal 3 by the electrolyte, in particular by a solvent present in the electrolyte.

If the electrolyte flows through the reservoir vessel 20a, 20b from bottom to top, as in the example shown, the further electrode 23 is preferably arranged downstream—in relation to the flow direction of the electrolyte—of the alkali metal 3, in particular of the alkali metal 3 in the second region 29. With progressive dissolution of the alkali metal 3, this can prevent electrical contact between the further electrode 23 and the alkali metal 3 in the second region 29 from breaking off due to floating of the alkali metal 3. Likewise, the electrode 22 is expediently arranged downstream of the alkali metal 3 in the first region 28.

If, on the other hand, the flow through the reservoir vessel 20a, 20b is from top to bottom, the preferred arrangement of the electrodes 22, 23 is expediently reversed.

FIG. 5 shows a further example of a reservoir vessel 20a, 20b of a device for enriching a substrate with an alkali metal 3. The reservoir vessel 20a, 20b differs from the reservoir vessel shown in FIG. 4 in particular in that the downstream electrode 22 is connected as anode, i.e. connected to the positive pole of the current or voltage source 24, while the upstream further electrode 23 is connected as cathode, i.e. to the negative pole of the current or voltage source 24. In addition, the separator 25 is expediently arranged such that the further electrode 23 cannot come into contact with the alkali metal 3. However, the separator 25 can optionally be dispensed with, for example if the further electrode 23 is arranged outside the filter 21.

The arrangement of the electrodes 22, 23 shown in FIG. 5 can be used to dissolve the alkali metal 3 in the electrolyte for enrichment of the substrate in the electrolysis chamber. Since the electrode 22, which is connected as anode and acts as an oxidizing agent, is arranged downstream of the further electrode 23, which is connected as cathode, the alkali metal 3 dissolved in the electrolyte can no longer reduce at the electrode 23, but is passed out of the reservoir vessel 20a, 20b through the electrolyte outlet 27.

In this variant, the further electrode 23 can be used to reduce again a partner substance dissolved in the electrolyte, which is oxidized at an anode in an electrolysis chamber of the device. In this case, the partner substance does not serve as a means of oxidizing the alkali metal. However, it can contribute on the one hand to the generation of a current flow or charge transport between the electrodes 22, 23 and/or on the other hand between the substrate serving as cathode and the anode in the electrolysis chamber.

FIG. 6 shows an example of a gas supply 50 for a reservoir vessel 20a, 20b in a device 1 for enriching a substrate 2 with an alkali metal 3. The device 1 is constructed essentially analogously to the device shown in FIG. 2. It differs from this only in the gas supply 50.

The gas supply 50 is preferably set up to introduce a gas 5 into the reservoir vessel 20a, 20b in order to dissolve the alkali metal 3 disposed therein by oxidation in the electrolyte 4 flowing through the reservoir vessel 20a, 20b. The gas supply 50 is therefore a means of oxidizing the alkali metal 3.

In the example shown, the gas 5 is generated at the anode 11 in the electrolysis chamber 10. Accordingly, it is expedient if the gas supply 50 has a gas collector 51, for example a gas extraction system, to collect the gas 5 generated at the anode 11. The collected gas 5 can be fed to the reservoir vessel 20a, 20b by means of a gas line 52. Optionally, a gas pump (not shown) is provided to pump the gas 5 from the gas collector 51 to the reservoir vessel 20a, 20b. The gas line 52 preferably flows into the reservoir vessel 20a, 20b, in particular below the alkali metal 3, for example below a bed of the same, so that the gas 5 exiting the gas line 52 can flow through the alkali metal 3 and thereby oxidize it.

In a variant of the device 1 shown in FIG. 5, the gas line 52 can also flow into a supply line to the reservoir vessel 20a, 20b upstream of the reservoir vessel 20a, 20b. In this case, the gas 5 is expediently dissolved in the electrolyte 4 or at least added to the electrolyte stream and flows with it into the reservoir vessel 20a, 20b.

Expediently, the gas 5 is obtained at the anode 11 from a conductive salt of the electrolyte 4, in particular a constituent of the conductive salt. For example, if lithium is used as alkali metal 3, LiCl is conceivable as conductive salt. Chlorine gas (Cl₂) can form at the anode 11 from the chloride anions in the electrolyte 4, which can be collected by the gas collector 51 and introduced via the gas line 52 into the reservoir vessel 20a, 20b. There, it expediently oxidizes the lithium so that lithium ions dissolve in the electrolyte 4 flowing through the reservoir vessel 20a, 20b. When the lithium is oxidized, the chlorine gas is reduced and also dissolves in the electrolyte 4. This has several advantages: the aggressive chlorine gas, which is harmful to health, produced at anode 11 can be recycled in a circular process and does not have to be disposed of. Accordingly, no or at least less chlorine gas is emitted. At the same time, the LiCl conductive salt is not “consumed” or at least less rapidly, and the risk of corrosion of the system can be reduced.

As an alternative to LiCl, LiNO₃ can also be used as conductive salt. A nitrous gas is then accordingly produced at the anode 11, which can be advantageous with respect to operational safety.

As an alternative to the gas supply 50 with a gas collector 51 shown in FIG. 5, a gas supply without gas collector 51 is also conceivable. In this case, the gas 5 can be withdrawn from a reservoir (not shown) for oxidation of alkali metal 3. When necessary, reaction products formed during the oxidation of the alkali metal 3 must then be removed from the electrolyte 4 by appropriate purification processes.

FIG. 7 shows an example of a method 200 and a device 1a for enriching an active material 7b of the substrate 2 with an alkali metal with the aid of a protective substance 4b. The device 1a has an electrolysis chamber 10 and a pump device 30, which is expediently connected to the electrolysis chamber 10 in a fluid-conducting manner. The electrolysis chamber 10 comprises an anode 11 and is set up to retain the substrate 2 as cathode 12. The anode 11 is expediently connected to the positive pole of a current or voltage source 13. The negative pole of the current or voltage source 13, on the other hand, can be connectable or connected to the substrate 2, i.e the cathode 12.

The electrolysis chamber 10 is expediently filled or can be filled with an electrolyte 4. The electrolyte 4 can be or is guided in the circuit K through the electrolysis chamber 10 with the aid of the pump device 30. Alkali metal dissolved in the electrolyte 4 can thus flow to the substrate 2 and enrich it. The alkali metal, in particular cations of the alkali metal, can be dissolved in the electrolyte 4, for example in an external reservoir vessel (see FIG. 2), by oxidation of the alkali metal or as a constituent of a conductive salt of the electrolyte 4.

The protective substance 4b is or is expediently also dissolved in the electrolyte 4. The protective substance 4b oxidizes in a preferred manner at the anode 11 and is reduced only in one or more predetermined sections 2a on the substrate 2. The one or more predetermined sections 2a are expediently the sections in which the substrate 2 is not covered with the active material 7b. In other words, the active material 7b defines at least one section 2b which is different from the one or more predetermined sections 2a.

If the substrate 2, for example, has a conductor foil 7a, for example a copper foil, which is coated with the active material 7b, the one or more predetermined sections 2a correspond in this respect to the “bare” conductor foil.

By reducing the protective substance 4b in the one or more predetermined sections 2a, a reduction of the alkali metal 3 and an associated deposition in these same sections 2a can be prevented or at least reduced. Therefore, the protective substance 4b is or is preferably selected such that an oxidation potential of the protective substance 4b is sufficient to dissolve the alkali metal in the one or more predetermined sections 2a of the substrate 2, but not the alkali metal embedded in the at least one section 2b different from the one or more sections 2a. Alternatively or in addition, the protective substance 4b is or is preferably selected such that a redox potential difference between the protective substance 4b and the substrate material in the one or more predetermined sections 2a of the substrate 2, for example on the “bare” conductor foil 7a, is greater than between the protective substance 4b and the substrate material in the at least one section 2a different from the one or more predetermined sections 2a, for example on or in the active material 7b. This can prevent the protective substance 4b from being embedded in the active material 7b.

Optionally, an undesirable detachment or release of the alkali metal already deposited on or embedded in the substrate 2 due to oxidation by the protective substance 4b can be avoided by feeding only a portion of the electrolyte 4 flowing along the anode 11 with the oxidized protective substance 4b directly to the substrate 2. Another portion of the electrolyte 2 can, as shown in FIG. 2, be fed via a reservoir vessel in which the protective substance 4b present in the electrolyte 2 is reduced so that it cannot reduce on the substrate and release the enriched alkali metal there. It is particularly advantageous here if the protective substance 4b also forms a partner substance for oxidizing the alkali metal in the reservoir vessel—and thus dissolves the alkali metal in the electrolyte (see FIG. 2 and the corresponding description).

Possible substances that can be used as protective substance 4b—and optionally also as partner substance—include metallocenes, dihydrophenazine, thiantlurene, triphenylamine, PFPTFBB, benzophenone, 1,3-benzodioxole, 1,3-di-tert-butyl-2,5-bis(2,2,2-trifluoroethoxy)benzene, phenothiazine and TEMPO, and all derivatives of these sub-stances.

### LIST OF REFERENCE NUMERALS

1 Device
1a Device
2 Substrate
2a Predetermined sections
2b Section different from the predetermined section
3 Alkali metal
4 Electrolyte
4a Partner substance
4b Protective substance
5 Gas
7a Conductor foil
7b Active material
10 Electrolysis chamber
11 Anode
12 Cathode
13 Current or voltage source
20a First reservoir vessel
20b Second reservoir vessel
21 Filter
22 Electrode
23 Further electrode
24 Current or voltage source
25 Separator
26 Electrolyte inlet
27 Electrolyte outlet
28 First region
29 Second region
30 Pump device
40 Control device
41 Valve arrangement
50 Gas supply
51 Gas collector
52 Gas line
60 Device
61 Anode
62 Cage
70 Device
71 Anode
100 Method
200 Method
S1 Method step
S2 Method step
K Circuit

1-34. (canceled)

35. A method for enriching a substrate with an alkali metal or with lithium, the method comprising:
guiding an electrolyte in a circuit through an electrolysis chamber having an anode and a cathode and through a reservoir vessel;
oxidizing and dissolving, in the electrolyte, an alkali metal or lithium disposed in the reservoir vessel; and
using the dissolved alkali metal to enrich a substrate, used as the cathode, in the electrolysis chamber.

36. The method according to claim 35, which further comprises providing the electrolyte with a partner substance for interacting with the alkali metal, the alkali metal disposed in the reservoir vessel being oxidized with assistance of the partner substance and dissolved in the electrolyte.

37. The method according to claim 36, which further comprises using an organic partner substance as the partner substance.

38. The method according to claim 36, which further comprises using at least one element from the group consisting of metallocenes, dihydrophenazine, dimethoxybenzene, thiantlurene, PFPTFBB, benzophenone, 1,3-benzodioxole, 1,3-di-tert-butyl-2,5-bis(2,2,2-trifluoroethoxy)benzene, phenothiazine, TEMPO and derivatives of the at least one element, as the partner substance.

39. The method according to claim 36, which further comprises reducing the partner substance in the reservoir vessel, during the oxidation of the alkali metal disposed in the reservoir vessel, to an extent of between least 80% and substantially completely.

40. The method according to claim 36, which further comprises providing the partner substance in a conductive salt dissolved in the electrolyte.

41. The method according to claim 40, which further comprises providing the conductive salt as lithium chloride or lithium nitrate, providing organic ions, chloride ions, nitrate ions, perchlorate ions or ozonide ions when dissolved in the electrolyte.

42. The method according to claim 36, which further comprises electrochemically treating the alkali metal disposed in the reservoir vessel.

43. The method according to claim 42, which further comprises using the electrochemical treatment to oxidize and dissolve the alkali metal in the electrolyte.

44. The method according to claim 42, which further comprises bringing the alkali metal in the reservoir vessel into contact with an electrode connected as the anode, and dissolving the alkali metal in the electrolyte by a flow of an oxidation current.

45. The method according to claim 43, which further comprises once again at least partially depositing, in the reservoir vessel, the alkali metal dissolved in the electrolyte by the electrochemical treatment.

46. The method according to claim 45, which further comprises causing the electrolyte to flow against a further electrode connected as a cathode, and placing the further electrode in the reservoir vessel downstream of at least a portion of the alkali metal, causing the alkali metal dissolved in the electrolyte to be deposited on the further electrode or on alkali metal having been brought into contact with the further electrode.

47. The method according to claim 44, which further comprises causing the electrolyte to flow against a further electrode connected as a cathode and disposed upstream of the alkali metal in the reservoir vessel, causing the partner substance to be reduced at the further electrode 23.

48. The method according to claim 35, which further comprises guiding the electrolyte in the reservoir vessel through a separator between two electrodes.

49. The method according to claim 35, which further comprises introducing a gas oxidizing the alkali metal into the reservoir vessel or dissolving the gas in the electrolyte upstream of the reservoir vessel, in order to dissolve the alkali metal disposed in the reservoir vessel in the electrolyte.

50. The method according to claim 49, which further comprises introducing a halogen gas or a nitrous gas into the reservoir vessel as the gas.

51. The method according to claim 49, which further comprises generating the gas at the anode in the electrolysis chamber.

52. The method according to claim 35, which further comprises oxidizing a protective substance present in the electrolyte at the anode and reducing the protective substance only in one or more predetermined sections on the substrate.

53. A method for enriching a substrate with an alkali metal or with lithium, the method comprising:
guiding an electrolyte, having an alkali metal dissolved in the electrolyte, in a circuit through an electrolysis chamber having an anode and a cathode;
enriching a substrate used as the cathode in the electrolysis chamber with the dissolved alkali metal; and
oxidizing a protective substance present in the electrolyte at the anode and reducing the protective substance only in one or more predetermined sections on the substrate.

54. The method according to claim 53, which further comprises actively controlling a concentration of cations of the protective substance in the electrolyte flowing onto the substrate.

55. The method according to claim 53, which further comprises selecting the protective substance:
to cause an oxidation potential of the protective substance to be sufficient to oxidize the alkali metal deposited on the substrate in the one or more predetermined sections and to dissolve the protective substance in the electrolyte, but
not to oxidize alkali metal embedded in the substrate in at least one section different from the one or more predetermined sections.

56. The method according to claim 53, which further comprises selecting the protective substance to cause a redox potential difference between the protective substance and a first substrate material in the one or more predetermined sections to be greater than between the protective substance and a second substrate material different from the first substrate material in at least one section different from the one or more predetermined sections.

57. The method according to claim 53, which further comprises selecting the protective substance added to the electrolyte from the group of metallocenes, dihydrophenazine, thiantlurene, triphenylamine, PFPTFBB, benzophenone, 1,3-benzodioxole, 1,3-di-tert-butyl-2,5-bis(2,2,2-trifluoroethoxy)benzene, phenothiazine, TEMPO and all derivatives of the protective substance.

58. The method according to claim 53, which further comprises providing a partner substance as the protective substance.

59. The method according to claim 58, which further comprises reducing the partner substance to an extent of between 70% and 90% during oxidation in the reservoir vessel.

60. The method according to claim 53, which further comprises providing the anode to be inert with respect to the electrolyte and substances dissolved in the electrolyte.

61. The method according to claim 53, which further comprises providing the anode with a noble metal or platinum or copper, or forming the anode of a noble metal or platinum or copper.

62. A method for using a substrate, the method comprising performing the method according to claim 35 to enrich the substrate, and using the enriched substrate as an electrode in a battery or in a lithium-ion battery or a lithium metal battery.

63. A device for enriching a substrate with an alkali metal or with lithium, the device comprising:
an electrolysis chamber having an anode, said electrolysis chamber configured to receive a substrate to be enriched with an alkali metal as a cathode;
a reservoir vessel for receiving the alkali metal;
an agent disposed in said reservoir vessel for oxidizing the alkali metal; and
a pump device for guiding an electrolyte in a circuit through said electrolysis chamber and said reservoir vessel, causing alkali metal oxidized in said reservoir vessel aided by the agent and thereby dissolved in the electrolyte to be provided in said electrolysis chamber and causing the substrate used as a cathode to be enriched with the dissolved alkali metal.

64. The device according to claim 63, which further comprises:
at least one of:
an electrode disposed in said reservoir vessel, or
a gas supply for introducing a gas oxidizing the alkali metal into said reservoir vessel or for dissolving the gas in the electrolyte upstream of said reservoir vessel;
said agent for oxidizing the alkali metal disposed in said reservoir vessel including a partner substance mixed with the electrolyte.

65. The device according to claim 63, wherein:
said reservoir vessel is one of a first reservoir vessel and a second reservoir vessel configured to receive the alkali metal; and
a control device is configured to guide the electrolyte through said first and second reservoir vessels:
causing the electrolyte to flow predominantly or substantially exclusively through said second reservoir vessel during a recharging of the alkali metal in said first reservoir vessel, and
causing the electrolyte to flow predominantly or substantially exclusively through said first reservoir vessel during a recharging of the alkali metal in said second reservoir vessel.

66. A device for enriching a substrate with an alkali metal or with lithium, the device comprising:
an electrolysis chamber having an anode, said electrolysis chamber configured to receive a substrate to be enriched with an alkali metal as a cathode;
an electrolyte containing a dissolved alkali metal and including a protective substance; and
a pumping device for guiding the electrolyte in a circuit through said electrolysis chamber, causing alkali metal dissolved in the electrolyte to be provided in said electrolysis chamber, causing the substrate used as a cathode to be enriched with the dissolved alkali metal and causing the protective substance present in the electrolyte to be oxidized at said anode and reduced only in one or more predetermined sections on the substrate.

67. An electrolyte, comprising:
a partner substance to be oxidized at an anode and to be reduced at an alkali metal;
the electrolyte being constituted to dissolve the alkali metal by oxidation aided by said oxidized partner substance.

68. An electrolyte, comprising:
an alkali metal dissolved in the electrolyte; and
a protective substance to be oxidized at an anode and to be reduced on a substrate used as a cathode only in one or more predetermined sections on the substrate;
the substrate not being able to be enriched with the alkali metal dissolved in the electrolyte in the one or more predetermined sections.
